(19) United States
(12) Patent Application Publication
(10) Pub. No.: US 2008/0080716 A1
(43) Pub. Date: Apr. 3, 2008

(54) Back-up for key authority point for scaling and high availability for stateful failover

(76) Inventors: Donald Kent McAlister, Apex, NC (US); Michael M. Sneed, Raleigh, NC (US)

Correspondence Address: TRIANGLE PATENTS, P.L.L.C., P.O. BOX 28539, RALEIGH, NC, 27611-8539, US

(21) Appl. No.: 11/540,235

(22) Filed: Sep. 29, 2006

(51) Int. Cl. H04L 9/00

(52) U.S. Cl. 380/279

(57) ABSTRACT

System and methods for simplified management of secured data and communications networks with a back-up for a key authority point for scalability and availability for stateful failover.

### BACKGROUND OF THE INVENTION

1. Field of the Invention

The present invention relates generally to secure communication and/or interaction within a secure network. More particularly, the present invention relates to systems and methods for providing a back-up for a key authority point providing key generation and distribution throughout a network.

2. Description of the Prior Art

Generally, current security solutions for networks include discrete solutions provided by security software and encryption algorithms and keys generated therefrom, network infrastructure, information technology (IT) infrastructure, and other enabling infrastructure, such as those provided by hardware and software for particular applications. Typically, changes to security solutions and even modifications within an existing security solution for a network requires complex adaptation and changes to the existing infrastructure, or are so cumbersome that use of encryption and security throughout most network activity is not commercially feasible or manageable, as shown in FIG. 1 (PRIOR ART).

Additionally, prior art secure network systems and methods require complex steps and configurations to arrange secure associations for devices to be operable for data access and communication across devices within a secure network. Therefore, security is actually diminished because full mesh is not commercially reasonable to manage and use in the normal course of business for even medium to large networks.

With the advent of the Internet, people are able to communicate with others without geographical limitations. Communication over the Internet has enabled people to work from remote locations, access information that would normally not be available from these locations. The Internet has also opened up a new frontier for online media delivery such as music and video. It has also enabled applications such as video conferencing and virtual private networking.

With the increased availability and variety of applications on the Internet, security is a major concern. If the communication between people is not secure, others can intercept and listen or view the conversations, view emails, join conferences, and gain access to secure documents and information. There are a number of solutions that address the problem of securing communication over the internet. The most common approach is to encrypt the communication so that only authorized users, or users that should receive and view the communication, can decrypt the communication. The users can also be authorized prior to sending them the encrypted information. This usually entails exchanging information with the users to be authorized to verify that they are who they claim to be. These techniques use cryptographic keys that are used to encrypt/decrypt the communication and/or verify and authorize users that have access to the communication.

The Internet Engineering Task Force (IETF) has defined a number of standards and RFCs to address this problem. However, these solutions, for example IPSec, are designed to enable one-to-one communication and are more concerned with the exact standards of carrying out encryption and authentication for secure message exchange.

The use of keys or the solutions provided by the IETF require that communication with each user or recipient by encrypted with a key. There are a number of key encryption techniques that can be used, such as symmetric or asymmetric techniques. As the number of recipients grows in a secure communication, for example, as in multicast applications such as conferencing and media broadcasting, the processing overhead required to encrypt the communication with each recipient grows. This also increases load on the hardware required to support the delivery of such applications to the recipients.

Another important aspect in the delivery of these applications is the management of keys. Keys are regularly sent to the recipients so that they can successfully authenticate themselves and decrypt the content. Key management requires keys to be generated for the recipients and distributed to them. The method in which the content is distributed may require a unique key for each recipient, or may support the use of common keys for multiple recipients. Further, keys need to be updated frequently since old keys may expire or may become available to users not intended to receive the keys, or rogue users. Also, recipients may support different key encryption/decryption algorithms. This requires multiple implementations of key encryption/decryption schemes. Finally, in distributing keys to the recipients, the keys may be intercepted and used by rogue users. Hence, the keys need to be encrypted themselves so that rogue users cannot decrypt and use them.

Hence, there is a clear need for a solution that will simplify the process of securing communication over unsecured mediums such as the internet. The solution should be able to reduce the number of encryption and decryption operations needed to securely transmit information to multiple recipients. It should also be able to manage individual user preferences and access levels. Further, the solution should be easy to implement using existing infrastructure and should be able to function with current standards of encryption and authentication. Additionally, the solution should be easy to manage and deploy. The system should be able to efficiently manage the generation and distribution of keys. It should enable access to the resources or content that is protected on the basis access levels assigned to users.

Other prior art key distribution provides for key management for multicasting, such as IPSec policy managers that define gateways within secure networks.

By way of example, current practice for providing secure group communications is represented by US Patent Application Publication No. 2004/0044891 for “System and method for secure group communications” by Hanzlik et al. published on Mar. 4, 2004 relating to implementation of a virtual private network group having a plurality of group nodes, a policy server, and shared keys for sharing encrypted secure communication information among the group nodes.

Where a key authority point (KAP) is provided as a solution to the foregoing systems and methods for providing secure network communication, the KAP is the central generator, distributor and repository for keys and policies for securing a network or networks via a set of policy enforcement points. If communication with the KAP were to fail, through network failure or KAP failure, secure networks would be unable to rekey themselves and communication would fail. In addition, new policies could not be sent to the network compromising network security.

A number of issues make securing a backup KAP difficult. By way of example, simply providing a duplicate KAP using clustering technology (e.g., the Linux High Availability system) involves sharing the secure keys across two devices over open communication. For security purposes, the keys should be stored in hardware and only communicated using the encryption key for the PEPs. A backup server using iSCSI (such as Distributed Replicated Block) suffers a similar limitation. On recovery, the backup KAP must be able to securely take over the network, ensuring it has the current keys and status information, without interrupting traffic in the network. The backup scheme for the KAP must be fully automated to ensure rapid backup and to preclude any state lockup during any transition no matter how complex. While it is acceptable for limited communication to both primary and backup be made (such as sending policies), the solution must not duplicate all traffic from primary and backup or the network will be overwhelmed. In any case, the solution must be robust enough to handle any single failure in communication, device functionality, and recovery without regard to timing.

Thus, there remains a need for a network security solution having simplified, effective key generation and distribution across the network, including back-up protocols for the key authority.

### SUMMARY OF THE INVENTION

The present invention provides systems and methods for providing back-up for a key authority point (KAP) to ensure management of secured networks with distributed keys and management of same for a data and/or communications network.

A first aspect of the present invention provides a system for management of secure networks including at least one management and policy (MAP) server constructed and configured for communication through a network via at least one key authority point (KAP) on the network, wherein the KAP is operable to generate and distribute keys based upon the policy communicated to the KAP by the MAP, and wherein the keys are provided to a multiplicity of policy enforcement point (PEP)s to ensure secure association across PEPs within the network, further including a back-up for the KAP to provide operability and rekeying without compromising network security in the event of a network or KAP failure.

Another aspect of the present invention provides methods for providing a back-up to the KAP for generating and distributing keys or rekeying for PEPs, wherein the keys are generated and distributed from a KAP based upon policy according to a MAP server, and the back-up functions to support the same policy following network or KAP failure.

In a preferred embodiment, the present invention provides systems and methods for providing a secure network and subnets including at least one management and policy (MAP) server constructed and configured for communication through a universal key authority point (KAP) that generates and distributes keys to policy enforcement points (PEPs) distributed across the network, the KAP generating at least one key according to MAP policy or policies to ensure secure association through the PEPs within the network, wherein the key generation and distribution operation by the KAP are automatic, based upon PEP request and MAP policy.

In another embodiment, the present invention provides automatic security solutions for enterprise data and communications management within a secure network wherein the policies and keys are managed and distributed by a MAP and a universal KAP, respectively, to PEPs for automatically configuring a secure network topography for authenticated and authorized communication across PEPs.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic of general PRIOR ART network security system arrangement.

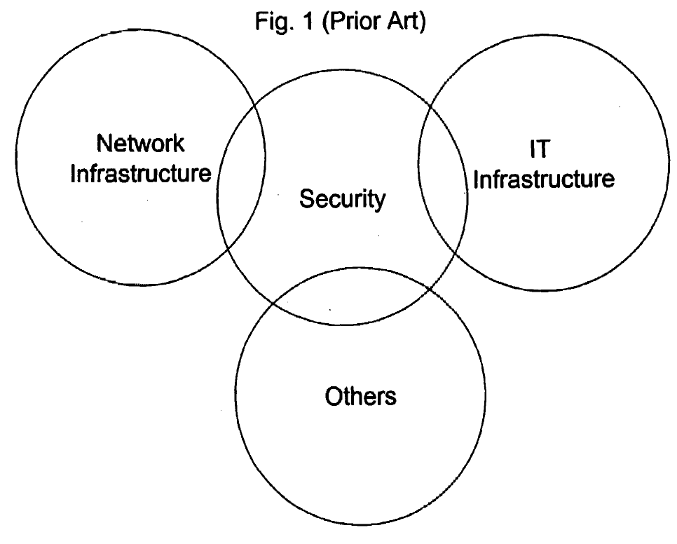

FIG. 2 is a schematic showing a centralized software solution for providing and managing security for data and communications of a network in accordance with an embodiment of the present invention.

FIG. 3 is a schematic diagram for the intelligent overlay of the present invention, and the MAP, KAP, PEP components.

FIG. 4 is a schematic diagram showing universal KAP for network protection.

FIG. 5 is a schematic showing the KAP for universal on-demand key generation services for all security needs.

FIG. 6 is a schematic diagram showing KAPs, PEPs and MAP nodes in a distributed network, in accordance with an embodiment of the present invention.

FIG. 7 is a schematic of PRIOR ART secure network mesh requirements.

FIG. 8 is a schematic of EDPM solution using the intelligent overlay according to the present invention.

FIG. 9 is a flow diagram for methods of back-up KAP functionality according to the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

As referred to herein, the term “encryption” includes aspects of authentication, entitlement, data integrity, access control, confidentiality, segmentation, information control, and combinations thereof.

The present invention provides a key and policy management software-based solution that enables secure data access and user interactions, and that enables users to securely access and interact with data they need and are authorized to access on predetermined, regular, and/or transactional bases from any point on the network without requiring changes in the existing infrastructure. The present invention system and method controls and manages the establishment and activity for trusted, secure connections across a network that are created by end point security technologies. This flexible software solution does not require a separate infrastructure to affect changes in network access, key or policy management.

Preferably, the system and methods of the present invention provide a network-independent solution layer or overlay that functions over the existing network infrastructure to control the policies, secure associations (SAs), and keys provided by a universal key authority point (KAP) to a multiplicity of policy enforcement points (PEPs) for enabling secure communications and data access to authorized users at any point within the network to other points, based upon the policies managed and provided by a management and policy server (MAP). The present invention provides for essentially unlimited scalability and address management that is commercially practical to implement network-wide for all secure communication, data access, applications, and devices, regardless of the type or form of encryption used by a particular device or hardware within the network. Also, the flexible software overlay for MAP and KAP functions within the system provides for dynamic modifications in real time without requiring changes to existing infrastructure or hardware, and without regard to the form of encryption thereon. Therefore, use and implementation of the present invention is not limited to traditional networking or infrastructure and is not limited to a single encryption form or type.

The present invention provides a method and a system for automatically securing communication between two or more nodes in a distributed network that use a single shared key or separate keys generated and distributed by a universal key authority point based upon a policy or policies managed by a management and policy server for the entire network.

A distributed network includes multiple nodes that are interconnected by multiple routers, bridges, etc. and that may be connected in a variety of different network topologies. In a distributed network, a node may be part of a smaller network such as an office LAN, or even a single node directly connected to the internet. The node can be connected to an unprotected network such as the Internet either directly or through a gateway, router, firewall and/or other such devices that allow one or more nodes to connect to a network via a single point. The nodes include computing devices such as, by way of example and not limitation, laptops, desktops, handheld devices, mobile devices, cable access systems, and other devices capable of connecting to a network, or a network of such devices.

These nodes communicate with each other, or servers providing services such as web pages, email, voice over internet protocol (VoIP), video broadcasting, multicasting applications, streaming audio or video via unprotected networks. In certain cases, when the communication is between two nodes that are using the same network, this communication may be protected. However, most of the communication over the internet is unprotected. This means that the communication can be intercepted by anyone. This communication is protected by using cryptographic keys. One or more nodes are grouped together so that they communicate over the unprotected networks via at least one policy enforcement point (PEP). Typically there are several PEPs in a distributed network. The PEPs receives policies from a management and policy server (MAP). The MAP defines the policies that govern the communication of the PEPs and the nodes under the PEPs. There are one or more key authority points (KAP) that communicate with the MAP and generate one or more cryptographic keys for PEPs. There are several configurations operable for arranging PEPs and KAPs within a network according to the present invention. By way of example, the system is operable for multiple KAPs, including peer KAPs, for one or more PEPs. Alternatively, the system and methods are functional where there is a single KAP that provides the keys for all the PEPs in a distributed network.

Based on the policies received from the MAP, the universal KAP of the present invention generates one or more cryptographic keys for each of the PEPs, or a single key to be shared by PEPs, within its network as defined by the MAP. The PEPs use the cryptographic keys to encrypt communication from the nodes and networks that they protect to unprotected networks, decrypt communication from unprotected networks to the nodes and networks that they protect or both. The universal KAP receives the policy definition from a single MAP. This policy definition informs the KAP about the PEPs it is responsible for, which networks the PEPs protect, and which KAP units they use. The KAP distributes the keys and policies associated with its networks and nodes to the appropriate PEPs.

In a system according to the present invention, a user defines the global networks and the MAP policy is established consistent with those definitions. The MAP then pushes down a meta policy to at least one KAP, which turns it into specific policies and corresponding keys for individual PEPs within the network. In one embodiment, the PEPs use a tunnel mode that includes a separate header for source and destination to provide a gateway for point to point connection. The inner header is copied to an outer header so that the same source and destination and layer 2 address is provided. This enables its use for load balancing or multicasting because the universal KAP and keys provided thereby to the PEPs provide for secure associations and communication across the network regardless of the form of encryption. The key(s) provided by the KAP enable any authorized PEP to communicate securely on the network even if the routing or distribution channel is modified for load balancing or multicasting.

Referring now to the drawings in general, the illustrations are for the purpose of describing a preferred embodiment of the invention and are not intended to limit the invention thereto.

The present invention provides management techniques or methods and systems to provide secure networks with distributed keys wherein the key sharing and distribution is simplified, i.e., management of key sharing and distribution is handled by a MAP in secure communication with key authority point(s) (KAP) that generate the keys in accordance with communicated MAP policy or policies.

Preferably the systems and methods of the present invention are applicable and operable over existing network management schemes without requiring a change in the hardware or configuration of the network.

In a particular embodiment as applied to IPSec, grouping of PEPs and KAPs in networks is protected, wherein the grouping is considered one entity that can be used in the policy. This provides for key sharing for multiple paths on PEPs and key distributors according to the present invention. This support for KAP and multiple PEPs provides for automatic predetermination of the configuration of the secure network.

More particularly, present invention provides systems and methods for simplified management of secured networks with distributed keys and management of same for a data and/or communications network through a KAP to PEPs or to peer KAPs for separate networks.

The system and method of the present invention are operable for a user to combine network sets to form a network topography wherein nodes across the network are functional to communicate across the network with other nodes and/or networks. By way of example, network topographies are selected from arrangements such as a mesh, hub-and-spoke, point-to-point, and combinations thereof. Where separate networks are provided, separate distributors or KAPs, such as peer KAPs, are operable to distribute the keys and policies from the universal KAP to the PEPs on those networks.

Generally, systems and methods according to the present invention provide for a single configuration point for the combined network sets based upon the type of policy but not being dependent upon the type or form of encryption at any node or for any packet or data communicated on the network. Settings for the combined network set are defined by the MAP and pushed out through the MAP to at least one KAP to PEPs for enforcement at the PEP level of the network without the user having to manually configure each node or network set within the network. This is uniquely provided by the present invention for the EDPM scenario wherein an entire network is configured and functions to provide a secure network for enterprise data policy management through a single MAP to at least one KAP to a multiplicity of PEPs automatically, based upon the policy established at the MAP, which provides for key generation and distribution through the at least one KAP to any PEPs authenticated and authorized according to the policy, regardless of the network configuration or topography. The nodes or network sets are combinable and configurable or re-configurable for cross communication based upon the established policy pushed down from the MAP to the at least one KAP, the keys from which enable the communication at any PEP.

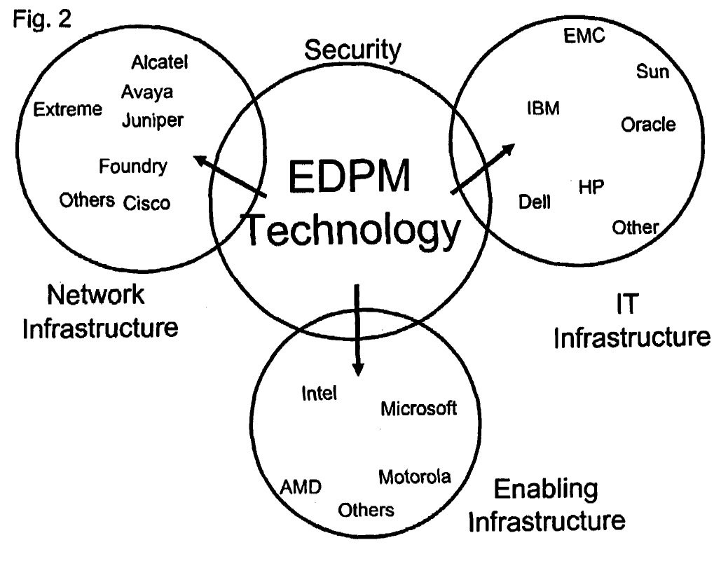

As best seen in FIG. 2, a schematic shows a centralized software solution for providing and managing security for data and communications of a network in accordance with an embodiment of the present invention. The central node 202 of this schematic provides the security of the network, wherein the EDPM (enterprise data protection management) technology includes the software overlay and becomes the central control and management solution for any network, without changing the network, IT, or enabling infrastructure represented by the outer nodes on this diagram. Within each of the nodes on this diagram, commercial product and/or software providers that are traditionally operating within those infrastructure areas are listed; these are representative of types of commercial providers in the space and are not intended to be limited thereto. This integratable software security solution layer of the present invention enables centralized policy management, centralized key authority, group policy management with access control, universal key authority and distribution, open protocol via an intelligent overlay architecture for flexible and dynamic changes that are independent of the infrastructure. Thus, the intelligent overlay software according to the present invention provides a transparent security utility for any network, but is also not limited to networks; while typically in this detailed description of the present invention the solution overlay is described for a network, in addition to network security, the overlay software solution is operable for entitlement, authentication, access control, data integrity, confidentiality, segmentation, information control, compliance, information and/or flows, applications, database access, storage networks, IT infrastructure, communications networks such as cellular, and combinations thereof in addition to network, data and communication security. Significantly, multiple security solutions can be combined together with the present invention overlay on a common infrastructure.

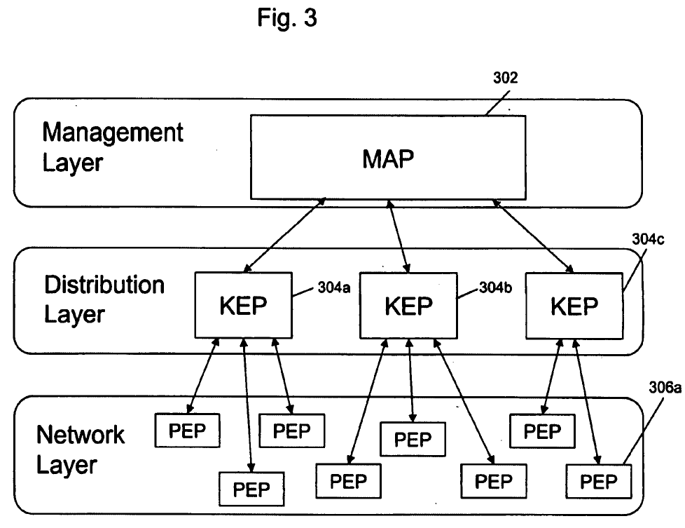

FIG. 3 shows a schematic diagram for the intelligent overlay of the present invention, including a management and policy server (MAP), at least one key authority point (KAP), that is designed to communicate through and open API to at least one policy enforcement point (PEP). MAP 302 provides a centralized or distributed management arrangement having a single interface for policy definition and enforcement that operates to authenticate each PEP 306 through existing AAA or other authentication services, and that pushes and enforces policy with the KAPs 304. The MAP 302 is preferably centralized to coordinate policy and entitlements from one source, and ties in existing AAA services and NMS.

The KAPs 304 function as a distribution layer; they are the key authority for the PEPs 306 to generate and distribute security associations (SAs) and keys to PEPs, monitoring PEP operation, supporting tunnel, transport, and network modes, and allow distributed and redundant deployment of keys to PEPs, and combinations thereof. The PEPs 306 are hardware or software-based PEPs, providing support for clients, blades, and appliances. The PEP policy and keys are enforced by the KAPs 304, while a PEP 306 authenticates KAP 304. The KAP 304 ensures that keys are sent only to the right places within the network, which provides for manageable scalability regardless of the number of PEPs 306 or SAs required.

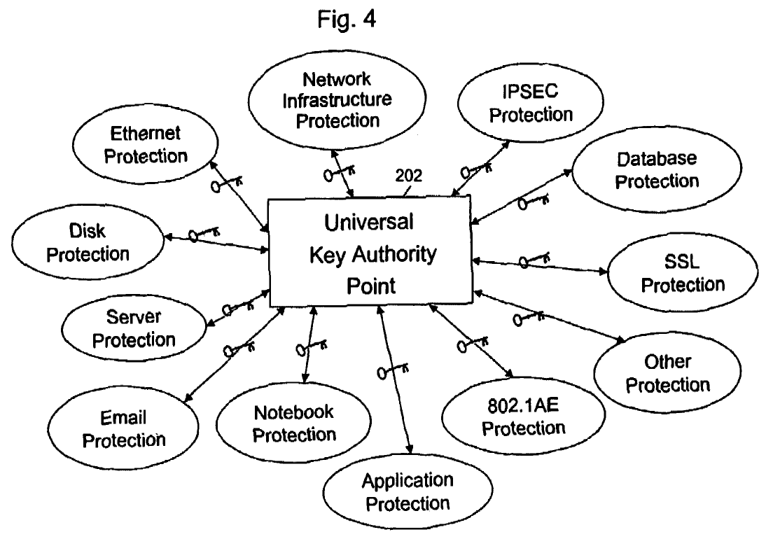

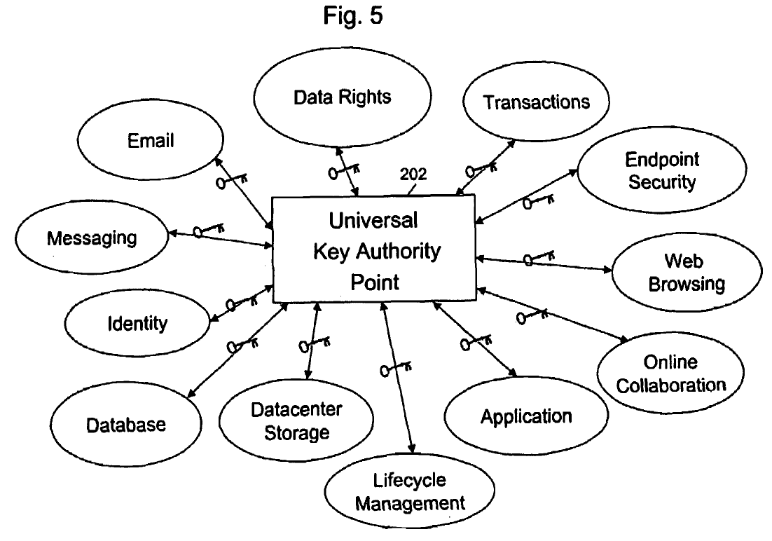

Furthermore, in a preferred embodiment of the present invention, the KAP is a universal KAP within the EDPM, and provides universal key generation and distribution services for the PEPs on the network. As such, the universal KAP ensures network infrastructure protection, Ethernet protection, disk protection, server protection, email protection, notebook computer protection, application protection, 802.1AE protection, IPSEC protection, database protection, SSL protection, other protection and combinations thereof, as shown in the schematic of FIG. 4. According to the present invention, the KAP provides universal on-demand key generation services for all security needs, including secure information such as data rights, email, messaging, and identity; secure infrastructure such as database, data center storage, lifecycle management, and applications; and secure interaction such as transactions, endpoint security, web browsing, and on-line collaboration, and combinations thereof, as illustrated in the schematic of FIG. 5.

The software overlay solution ensures flexibility for multi-vendor support as illustrated in FIG. 2 representative vendors, wherein this support flexibility is designed in through API according to an embodiment of the present invention. Significantly, network security is enforced at every end point or PEP on the network level through an open API; PEPs include any end point, by way of example and not limitation, mobile devices such as PDAs, storage, servers, VPN clients, and networking, and combinations thereof.

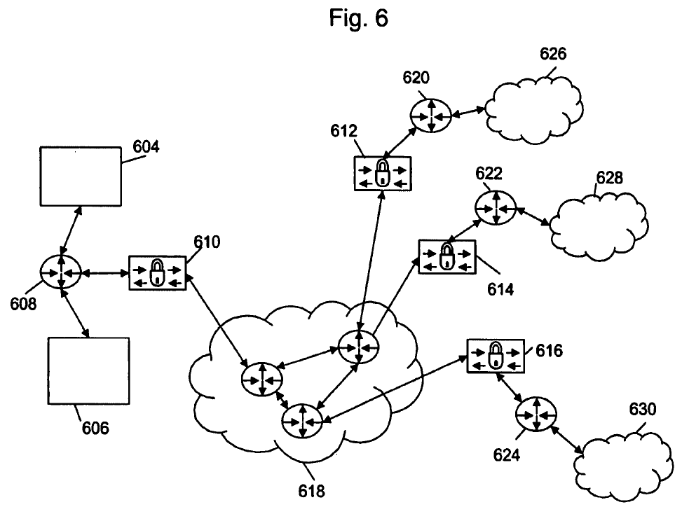

FIG. 6 is a schematic diagram showing KAPs, PEPs and MAP nodes in a distributed network, in accordance with an embodiment of the present invention. A management and policy (MAP) server 604 and a key authority point (KAP) 606 are connected to a network node 608. Network node 608 connects to a policy enforcement point (PEP) 610. PEPs 612, 614 and 616 are also connected to PEP 610 via an unprotected network 618. Unprotected network 618 is a network of interconnected nodes and smaller networks, such as the internet or a local LAN or WAN. PEPs 612, 614 and 618 are connected to network nodes 620, 622 and 624 respectively. The network nodes may be individual network points or can be access points to sub-networks 626, 628 and 630. KAP 606 generates and sends keys to PEPs 610, 612, 614 and 616. The keys enable PEPs to encrypt and/or authorize communication between the PEPs 610, 612, 614 and 618 and the nodes behind the PEPs. In an alternate embodiment, MAP 604 and KAP 606 are implemented as programs that reside on network node 608.

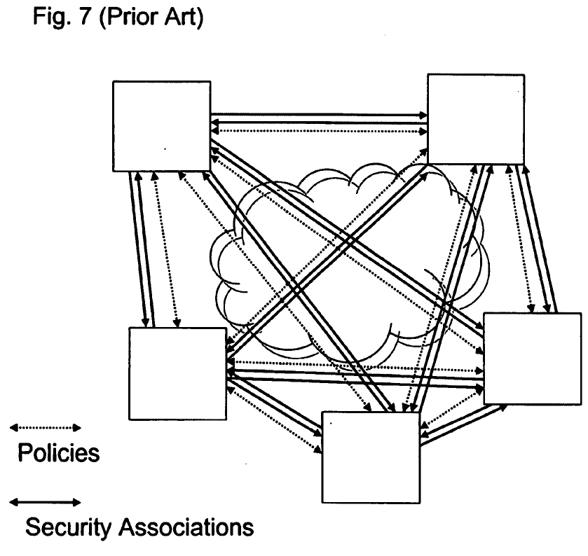

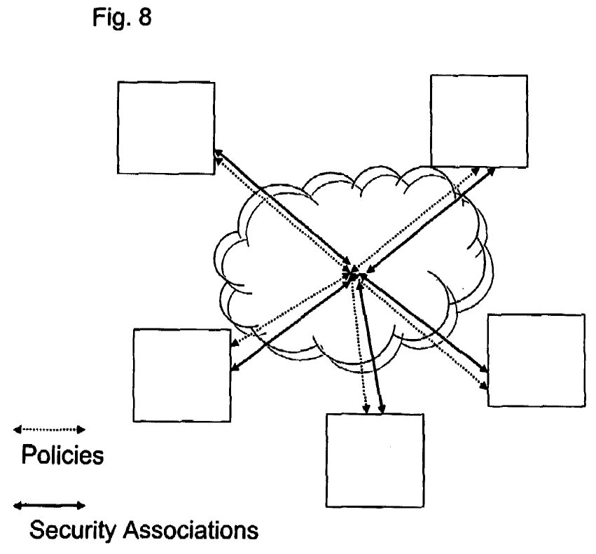

By sharp contrast to the prior art illustrated in FIG. 7 (Prior Art), wherein encryption in traditional data protection requires a large number of policies to provide a full mesh of secure interconnectivity, twice that number of security associations (SAs) for the same, and significant change to the network is required, the intelligent overlay for secure networks according to the present invention using EDPM requires a small, limited number of policies and SAs for a full mesh, and no change to the network infrastructure is required, as illustrated by the schematic of FIG. 8. Alternative embodiments of the networks using EDPM include but are not limited to a hierarchical structure, multicast group, and broadcast group.

In a preferred embodiment, the present invention provides systems and methods for providing secure networks as set forth hereinabove, further including back-up KAP. In any case hereinabove where KAP is mentioned, the present invention provides for at least two KAPs, specifically including a primary KAP and a back-up KAP. Preferably, the primary and back-up KAPs share a common or the same KAP name such that they appear to be identical to the PEPs. Only the latest information will be used by the PEPs.

The system for providing secure networks includes a communication network having a network infrastructure and software operating on a management and policy (MAP) server in connection to the network for providing security for the network; at least two key authority points (KAPs), including a primary KAP and a back-up KAP, wherein the MAP includes at least one policy for providing secure association (SA) between policy enforcement points (PEPs) having nodes within the network. The primary KAP is operable to generate, distribute, and manage key(s) communicated to the multiplicity of PEPs and the back-up KAP is operable to function as the primary KAP in any event that prevents the primary KAP from functioning to ensure that the network automatically provides a network topography of secure communication based upon the policy and keys distributed to the PEPs for any encryption form at the nodes.

In the event that the back-up KAP is required to take over functions for a non-functioning or missing primary KAP, the back-up KAP is operable to force a re-key for all policies upon taking over functions for the primary KAP; thereafter, the primary KAP is operable to use re-key to recover. Advantageously, the back-up KAP is operable to gain full knowledge of the network and store keys without transferring keys or interrupting traffic on the network.

The present invention also provides a method for providing secure interactivity between points on a network including the steps of:

providing a communication network having a network infrastructure between at least two policy end points (PEPs);

providing an intelligent software overlay that is independent of the network infrastructure, the software overlay operating on a server in connection to the network for providing security for the network; wherein the intelligent software overlay further includes: a management and policy (MAP) server coupled to the network for communication with at least two key authority points (KAPs), including a primary and a back-up KAP;

the MAP establishing and managing at least one policy for providing secure association (SA) between PEPs within the network;

the primary KAP generating, distributing, and managing keys and providing them to the PEPs and/or to peer KAPs through an open API;

the PEPs having secure exchange over the network using the keys provided directly or indirectly by the KAP, regardless of the form of encryption on any device or corresponding node on the network; and

the back-up KAP functioning identically to the primary KAP in the event of the primary KAP being inoperable or unable to function normally.

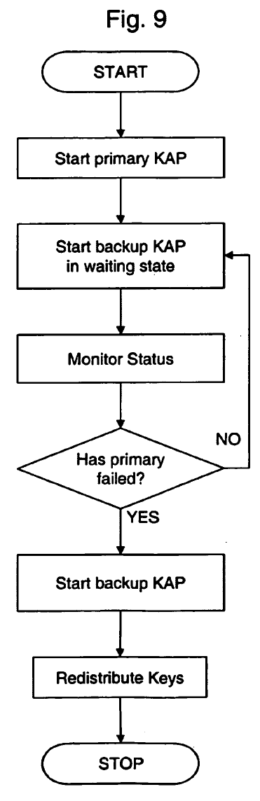

The state functioning of the primary and backup KAP is described below and illustrated in the flow diagram of FIG. 9:

### 1. Backup/primary should be in configuration of KAP.

An implementation could be done where the setting of backup or primary was in the metapolicy sent from the MAP.
   2. Create KAP running state:
BackupWaiting
BackupRunning
PrimaryRunning
PrimaryWaiting

### This is preferably best done adding an item to KGDPStatus.

### 3. Add message BackupCompareStatus(KGDPStatus status) which returns getCoreStatus (no node information).

KGDPStatus status BackupCompareStatus(KGDPStatus status)
Sends the sender's status from getCoreStatus( )
The receiver should check the name and version with the receiver's getCoreStatus( ):
   If these do not match and if the sender's timestamp is older, the receiver should sent DistributePolicyMessage(meta,deployedStatus) with its metapolicy.
   Note: This should be sent independent of returning from the BackupCompareStatus( ) call (e.g. a separate thread).
   Note: We may need to change the status timestamp to use the meta install time.
Returns the receiver's status from getCoreStatus( )
In all cases, on unit startup, this should block until the metapolicy has been loaded from the file (either success or fail).
   This is to ensure the information returned in status is current.

### 4. Power up in waiting state based on primary/backup configuration.

On power up, load the stored metapolicy and state and determine if the KAP is primary or backup.
   In backup, do not call_manager.start( ).
Enter the running state accordingly
   PrimaryWaiting
   BackupWaiting

### 5. State activities

PrimaryWaiting (Entered only at startup)
   Load metapolicy and state.
   If no metapolicy or no backup defined in metapolicy:
      Enter PrimaryRunning state
      Continue with installInitialMetapolicy using the metapolicy loaded from the file (if any).
   If backup in metapolicy:
      Proceed with installInitialMetapolicy through createCommunicationDestinations( ).
      Send backup KAP BackupCompareStatus(coreStatus). We can use the blocking call here. (Note: Primary only sends BackupCompareStatus on metapolicy load—not on a periodic basis.)
         Don't call_manager.start( ) yet
         If no reply in timeout period:
            Enter PrimaryRunning state
            Continue with installInitialMetapolicy using the metapolicy loaded from the file.
         If in the returned status, the metapolicy name and version match the stored info:
            Enter PrimaryRunning state
            Continue with installInitialMetapolicy using the metapolicy loaded from the file.
         If in the returned status, the metapolicy does not match and is older:
            Set independent call to DistributePolicyMessage to the backup KAP with the stored metapolicy.
            Enter PrimaryRunning state
            Continue with installInitialMetapolicy using the metapolicy loaded from the file.
            If the returned status has a new metapolicy name or version:
            Enter PrimaryRunning state
            Remove the metapolicy loaded from the file (set_meta to null)
            Continue with installInitialMetapolicy.
            Note this will start the KAP with no loaded policies waiting for a new metapolicy.
            The backup should see the mismatch and send a new metapolicy.
      Note that the primary stays in PrimaryWaiting and not monitoring the message queue (no_manager.start( ) call) until a timeout or a reply occurs.
      Received messages:
         GetStatus:
            Return getCoreStatus while in PrimaryWaiting.
         BackupCompareStatus(status)
            Compare status and, if backup older, send DistributePolicyMessage(currentMetapolicy, deployedStatus).
            Reply with getCoreStatus( )
         Place other messages on the queue as they are now.
PrimaryRunning: Same as current.
   BackupCompareStatus(status)
      Compare status and, if backup older, send DistributePolicyMessage(currentMetapolicy, deployedStatus).
      Reply with getCoreStatus( )
BackupWaiting
   On entry:
      clearExistingMetapolicy to delete nodes, policies and keys.
      At defined interval:
         Send BackupCompareStatus(coreStatus) to primary KAP
            If no reply after backup wait timeout (configured), enter BackupRunning state.
            If metapolicy matches but deploy status has changed to DEPLOYED, store this in the state file.
            If the primary metapolicy doesn't match and is older, send
            DistributePolicyMessage(currentMetapolicy, deployedStatus).
            Note: Even if primary gets another from MAP at the same time, it will just ignore one as a repeat.
   Received messages:
      GetStatus:
         Return getCoreStatus.
      BackupCompareStatus(status)
         Compare status and, if backup older, send DistributePolicyMessage(currentMetapolicy, deployed Status).
         If metapolicy matches but deploy status has changed to DEPLOYED, store this in the state file.
         Reply with getCoreStatus( )
      distributeNewPolicy(meta)
         Check, store and update status with name as is done now.
         Note: Don't put message on queue.
      Ignore other messages but reply appropriately.
BackupRunning
   On entry:
      Call KGDPManager.start( )
Subsequently, behave exactly as the primary (same as now) except as noted below.
   At defined interval:
      Send BackupCompareStatus(coreStatus) to primary KAP
If primary replies:
   If the primary metapolicy doesn't match and is older, send
   DistributePolicyMessage(currentMetapolicy, deployed Status).
   Enter BackupWaiting state
   Received messages:
      GetStatus:
Return getCoreStatus.
   BackupCompareStatus(status)
If the primary metapolicy doesn't match and is older, send DistributePolicyMessage(currentMetapolicy, deployedStatus).
If metapolicy matches but deploy status has changed to DEPLOYED, store this in the state file.
Enter BackupWaiting state
Reply with getCoreStatus( )
   Other messages handled as current (as PrimaryRunning)

### 6. Modify MAP and peer KAPs to send all messages to backup as well as to primary.

As set forth hereinabove, the system and methods of the present invention provide for functional, dynamic security groups on a given network both inside and outside organizational boundaries and across geographical locations, including full KAP functionality using a primary and back-up KAP to ensure uninterrupted traffic. The result is a flexible security solution that is operable to be responsive to different security requirements for different groups of users and applications, all while providing back-up KAP functionality without interrupting network traffic or transferring keys.

Certain modifications and improvements will occur to those skilled in the art upon a reading of the foregoing description. By way of example, in one implementation, the primary and backup KAP can be configured in the policy allowing a change of roles if necessary without reconfiguration.

The above mentioned examples and embodiments are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for providing secure networks comprising:
a communication network having a network infrastructure; and
software operating on a server in connection to the network for providing security for the network; wherein the software provides:
a management and policy (MAP) server coupled to the network for communication with at least two key authority points (KAPs), including a primary KAP and a back-up KAP,
wherein the MAP includes at least one policy for providing secure association (SA) within the network;
wherein the primary KAP is operable to generate, distribute, and manage key(s) communicated to a multiplicity of policy enforcement points (PEPs) having nodes distributed throughout the network;
wherein the back-up KAP is operable to function as the primary KAP in any event that prevents the primary KAP from functioning,
and wherein the network automatically provides a network topography of secure communication based upon the policy and keys distributed to the PEPs for any encryption form at the nodes
thereby providing a secure, flexible network security solution.

2. The system of claim 1, wherein the back-up KAP is operable to force a re-key for all policies upon taking over functions for the primary KAP.

3. The system of claim 2, wherein the primary KAP is operable to use re-key to recover.

4. The system of claim 2, wherein the back-up KAP is operable to gain full knowledge of the network and store keys without transferring keys or interrupting traffic on the network.

5. The system of claim 1, wherein the KAP is operable to reconfigure secure PEP interactivity without requiring change to the network infrastructure.

6. The system of claim 1, wherein the KAP is operable to communicate key(s) and policy to peer KAP(s).

7. The system of claim 1, wherein the primary and back-up KAPs share a common name such that the PEPs consider them to be identical.

8. A method for providing secure interactivity between points on a network comprising the steps of:
providing a communication network having a network infrastructure and a secure network topography between a multiplicity of policy enforcement points (PEPs) having nodes with any form of encryption associated therewith;
a user providing at least one policy definition to a management and policy (MAP) server in communication with at least two key authority points (KAPs), including a primary KAP and a back-up KAP;
the primary KAP generating and distributing at least one key to the PEPs consistent with the MAP policy;
the PEPs enforcing the policy at the nodes to provide secure communication across the network topography;
the primary KAP failing its normal operation;
the back-up KAP forcing a re-key and taking over original functions of the primary KAP.

9. The method of claim 8, further including the step of the back-up KAP gaining full knowledge of the network and storing current keys.

10. The method of claim 9, wherein the step of the back-up KAP gaining full knowledge of the network and storing current keys occurs without transferring keys or interrupting traffic on the network.

11. The method of claim 8, further including the step of the primary KAP recovering and using a re-key to regain its primary functionality.

12. The method of claim 8, wherein the primary and back-up KAP are using a common KAP name such that they appear to be identical to the PEPs.

13. The method of claim 12, wherein the PEPs only use the latest information provided by either KAP.

14. A method for state functioning of a primary key authority point (KAP) and a back-up KAP within a system for providing secure network communication, the system including a communication network having a network infrastructure and software operating on a management and policy (MAP) server in connection with the network for providing security for the network through communication with at least two key authority points (KAPs), including a primary KAP and a back-up KAP, which are operable to provide keys and policies to a multiplicity of policy enforcement points (PEPs), the method including the steps of:
the primary KAP generating, distributing, and managing the keys communicated to the PEPs;
the primary KAP failing to function;
the back-up KAP activating to function as the primary KAP;
the back-up KAP re-keying for all policies;
thereby providing uninterrupted traffic across the network.

15. The method of claim 14, further including the step of the back-up KAP gaining knowledge of the network and storing current keys without transferring keys or interrupting network traffic.

16. The method of claim 14, wherein the primary KAP and back-up KAP use the same KAP name to appear identical to the PEPs.
